(19) United States
(12) Patent Application Publication
(10) Pub. No.: US 2014/0148289 A1
(43) Pub. Date: May 29, 2014

(54) Speed Reduction Device

(71) Applicant: RBC MANUFACTURING CORPORATION, Beloit, WI (US)

(72) Inventors: Larry Gene Anderson, Aberdeen, SD (US); Simon Andrew Odland, Aberdeen, SD (US); James Michael Campbell, Aberdeen, SD (US)

(73) Assignee: RBC Manufacturing Corporation, Beloit, WI (US)

(21) Appl. No.: 13/687,450

(22) Filed: Nov. 28, 2012

(51) Int. Cl. F16H 7/02

(52) U.S. Cl. CPC F16H 7/02
USPC 474/150

(57) ABSTRACT

A speed reduction device for cooperation with a mechanical power source and with a mechanical power load is described. The device includes a housing an input shaft and a second shaft. The device also includes a first pulley a second pulley and a belt. The input shaft is rotatably supported by the housing and located at least partially within the housing. The second shaft is rotatably supported by the housing and located at least partially within the housing. The first pulley is operably associated with the input shaft and located within the housing. The second pulley is operably associated with the second shaft and located within the housing and the belt connects the first pulley to the second pulley and is located within the housing.

### BACKGROUND OF THE INVENTION

The embodiments described herein relate generally to a speed reducing device, and more specifically, to a speed reducing device utilizing belts.

Mechanical devices are often driven by an input power source that rotates at a higher speed than that required by the mechanical device. Such power input devices are often electric motors with high rotational speed. A speed reduction device is thus often used to provide the proper speed for the mechanical device. The speed reduction device is often in the form of a gear drive enclosed in a housing. Oil or other lubricant is often used to lubricate the gears, requiring maintenance to keep the oil at a proper lever and ensure that the oil does not leak from the housing, damaging the gears and contaminating the area adjacent the housing.

Occasionally, a belt and pair of pulleys are used to reduce the speed of a mechanical device and are an integral part of the mechanical device. The belt is limited in its load carrying capacity, the differences in the sizes of the pulleys is limited, limiting the speed reduction such devices can provide, and the sizes of the belt and pulleys cause the speed reduction device to occupy large precious space within the mechanical device.

A need exists for a mechanical speed reducing device that does not require excessive maintenance, is modular and compact, and can transmit heavy loads to the mechanical device.

### BRIEF DESCRIPTION OF THE INVENTION

In one aspect, a speed reduction device for cooperation with a mechanical power source and with a mechanical power load is described. The device includes a housing, an input shaft and a second shaft. The device also includes a first pulley, a second pulley and a belt. The input shaft is rotatably supported by the housing and located at least partially within the housing. The second shaft is rotatably supported by the housing and located at least partially within the housing. The first pulley is operably associated with the input shaft and located within the housing. The second pulley is operably associated with the second shaft and located within the housing and the belt connects the first pulley to the second pulley and is located within the housing.

In another aspect, a speed reduction device for cooperation with a mechanical power source and with a mechanical power load is described. The device includes a housing, an input shaft and a second shaft. The input shaft is rotatably supported by the housing and located at least partially within the housing. The second shaft is rotatably supported by the housing and located at least partially within the housing. The device also includes a first pulley operably associated with the input shaft and located within the housing. The device also includes a second pulley operably associated with the second shaft and located within the housing. The device also includes a first belt operably connecting the first pulley to the second pulley and located within the housing. The device also includes a third shaft rotatably supported by at least one of the housing and the input shaft. The device also includes a third pulley operably associated with the second shaft and located within the housing. The device also includes a fourth pulley operably associated with the third shaft and located within the housing. The device also includes a second belt operably connecting the third pulley to the fourth pulley and located within the housing.

In a further aspect, a speed reduction device for cooperation with a mechanical power source and with a mechanical power load is disclosed. The device includes a housing, an input shaft and a second shaft. The input shaft is rotatably supported by the housing and located at least partially within the housing. The second shaft is rotatably supported by the housing and located at least partially within the housing. The device also includes a first pulley operably associated with the input shaft and located within the housing. The device also includes a second pulley operably associated with the second shaft and located within the housing. The device also includes a first belt operably connecting the first pulley to the second pulley and located within the housing. The device also includes a third shaft rotatably supported by at least one of the housing and the input shaft. The device also includes a third pulley operably associated with the second shaft and located within the housing. The device also includes a fourth pulley operably associated with the third shaft and located within the housing. The device also includes a second belt operably connecting the third pulley to the fourth pulley and located within the housing. The device also includes a fourth shaft rotatably supported by at least one of the housing and the second shaft. The device also includes a fifth pulley operably associated with the third shaft and located within the housing. The device also includes a sixth pulley operably associated with the third shaft and located within the housing and a third belt operably connecting the fifth pulley to the sixth pulley and located within the housing.

In yet another aspect, a method for reducing the speed of a drive is disclosed. The method includes the steps of providing a housing, providing an input shaft rotatably supported by the housing and located at least partially within the housing, providing a second shaft rotatably supported by the housing and located at least partially within the housing, providing a first pulley operably associated with the input shaft and located within the housing, providing a second pulley operably associated with the second shaft and located within the housing and providing a belt operably connecting the first pulley to the second pulley and located within the housing.

### BRIEF DESCRIPTION OF THE DRAWINGS

FIG. 1 is perspective view of an exemplary speed reducing device, with a portion of its housing removed;

FIG. 2 is a perspective view of the speed reducing device shown in FIG. 1;

FIG. 3 is another perspective view of the speed reducing device shown in FIG. 1 with a portion of the shown as a cutaway;

FIG. 4 is a side elevational view of the speed reducing device shown in FIG. 1;

FIG. 5 is a cross sectional view of FIG. 4 along the line 5-5 in the direction of the arrows.

FIG. 6 is a perspective view of another exemplary speed reducing device;

FIG. 7 is a plan view of the speed reducing device shown in FIG. 6;

FIG. 8 is a cross sectional view of FIG. 7 along the line 8-8 in the direction of the arrows;

FIG. 9 is a partial plan of another exemplary speed reducing device including an eccentric mounting device to adjust belt tension; and

FIG. 10 is a flow chart of an exemplary method for assembling the electric motor shown in FIG. 1.

### DETAILED DESCRIPTION OF THE INVENTION

The methods, systems, and apparatus described herein provide for torque transfer to a device with a change in rotational speed from the power source to the device. The torque transfer is provided by a device that is enclosed and consists of a plurality of shafts and gears that provides the change in rotational speed. The gears require oil for lubrication and must be contained by seals around the input and output shafts that extend from the housing. The oil that evaporates and leaks from the housing must be continuously monitored and replenished, requiring constant maintenance of the device.

The methods, systems, and apparatus described herein provide a device that does not require oil, does not leak oil and does not require the adding of oil. The methods, systems, and apparatus described herein may also eliminate the need of seals at the shaft. Furthermore, the methods, systems, and apparatus described herein permit the transfer of high torque in a small space. Also, the methods, systems, and apparatus described herein provide for a device that may be added to another mechanical device.

Technical effects of the methods, systems, and apparatus described herein include at least one of improved quality, reduced material cost, and reduced labor costs.

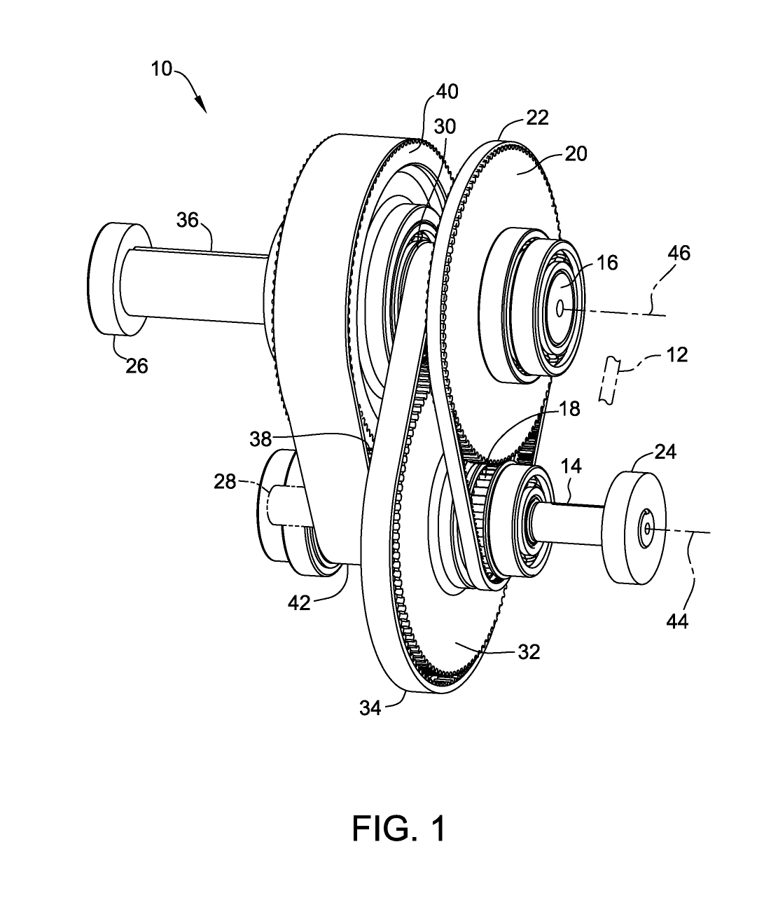

FIG. 1 is a plan view of an exemplary speed reduction device 10. In the exemplary embodiment, the speed reduction device 10 includes a housing 12 for supporting an input shaft 14 and a spaced apart second shaft 16. A first pulley 18 is connected to the input shaft 14 and a second pulley 20 is connected to the second shaft 16. A first belt 22 wraps around the first pulley 18 and the second pulley 20, transmitting torque from the input shaft 14 to the second shaft 16.

To accomplish speed reduction, the first pulley 18 is smaller than the second pulley 20, the speed reduction being proportional to the relative diameters of the pulleys. It should be appreciated that the device of the present invention could serve as a speed increasing device if the relative diameters of the pulleys are reversed.

It should be appreciated that the device of the present invention could merely include the housing 12 supporting the first and second shafts 14 and 16 which carrying the first and second pulleys 18 and 20. The belt would transfer torque from the input shaft 12 to the second shaft 14. Since the device does not use gears, such a device would provide for a self-contained speed reduction device free from the need to monitor the oil level within the housing. The device could be positioned between a power source 24 and a load 26.

To obtain additional speed reduction and, as shown in FIG. 1, the device includes additional speed reduction in addition to that provided by first and second pulleys 18 and 20. For example, the speed reduction device 10 includes a third shaft 28. A third pulley 30 is secured to the second shaft 16 and a fourth pulley 32 is secured to the third shaft 28. A second belt 34 wraps around the third pulley 30 and the fourth pulley 32, transmitting torques from the second shaft 16 to the third shaft 28.

While the third shaft 28 may be positioned in any position spaced from the second shaft 16, the positions of the shafts 14, 16 and 26 limit the minimum size of the device 10. Since space is at a premium in most mechanical devices, minimizing the size of the device is important. The applicants have discovered that the first and third shafts 14 and 28 may be positioned about a common axis of rotation. This positioning minimizes the size of the device 10.

To obtain even further additional speed reduction and as shown in FIG. 1, the device includes further speed reduction in addition to that provided by first, second, third and fourth pulleys 18, 20, 30 and 32. The device 10 further includes a fourth shaft 36. A fifth pulley 38 is secured to the third shaft 28 and a sixth pulley 40 is secured to the fourth shaft 36. A third belt 42 wraps around the fifth pulley 38 and the sixth pulley 40, transmitting torque from the third shaft 28 to the fourth shaft 36.

While the fourth shaft 36 may be positioned in any position spaced from the third shaft 28, the positions of the shafts 14, 16, 28 and 36 limit the minimum size of the device 10. As stated above, since space is at a premium in most mechanical devices, minimizing the size of the device is important. The applicants have discovered that the second and fourth shafts 16 and 36 may be positioned about a common axis of rotation. This positioning minimizes the size of the device 10.

It should be appreciated that since the second and fourth shafts 16 and 36 are positioned about a first common axis of rotation 46 and the input and third shafts 14 and 28 are positioned about a second common axis of rotation 44, the distances between the first and second pulley centerlines, between the third and fourth pulley centerlines between the fifth and sixth pulley centerlines must all be the same. Therefore the size of the pulleys 18, 20, 30, 32, 38 and 40 and the sizes of the belts must be selected to provide for this common distance between the shafts.

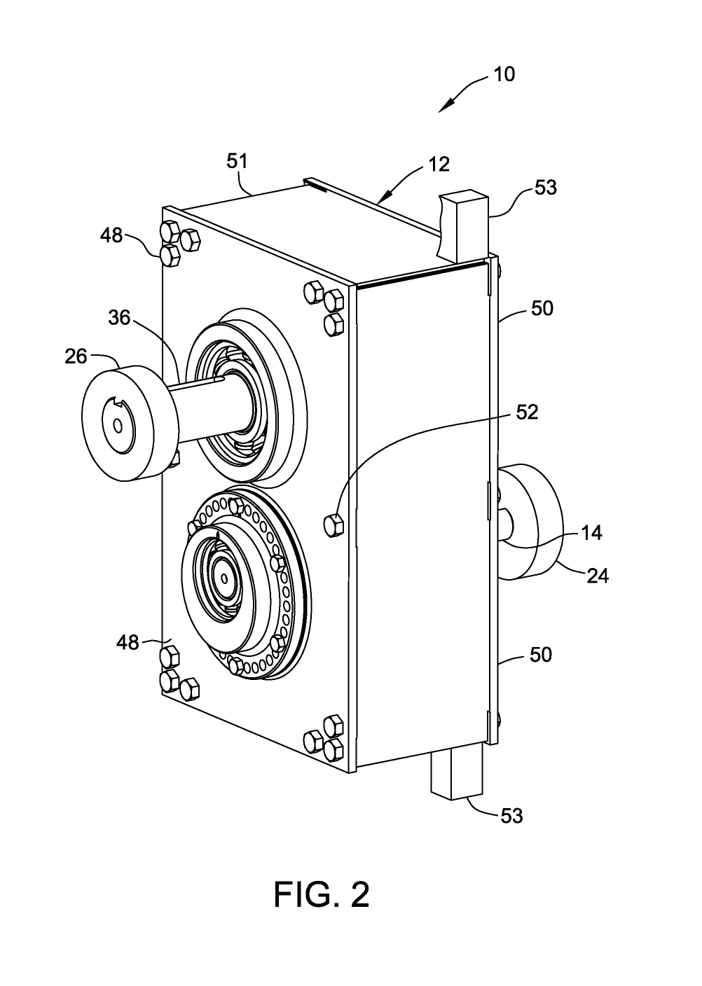

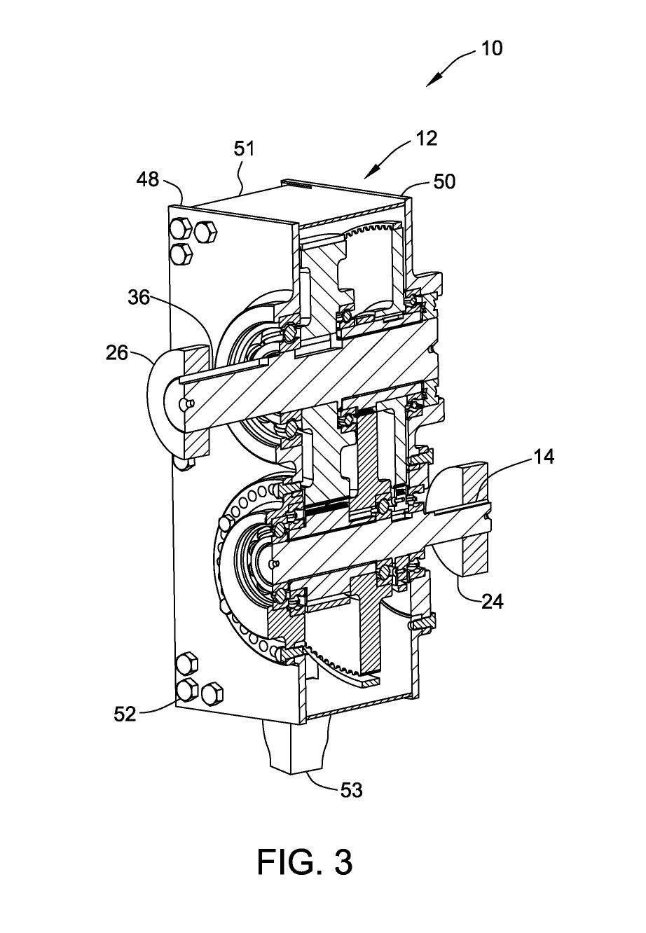

Referring now to FIGS. 2-3, the housing 12 is shown in greater detail. The housing 12 may be made of any of a number of suitable durable material, including, but not limited to metals, polymers, composites. The housing may be made by any suitable technique, such as by molding, casting or fabricating. As shown, the housing 12 is made of a metal and fabricated from steel plate. The housing may be integral or be made from two or more components. The housing 12, as shown, is made from first and second steel plate end portions 48 and 50, respectively which are connected to central portion 51. The portions 48, 50 and 51 permit access to the interior of the housing 12 to permit machining of the housing and to facilitate assembly. The housing portions are joined by fasteners 52. Brackets 53 may be used to secure the housing 12 to the machine (not shown).

The housing 12 may, alternatively, be made of any suitable durable material capable of proper support of the shafts. For example, the housing may, alternatively, be made of a metal, a polymer, a composite or any combination thereof. The housing may, alternatively, be fabricated in any suitable manner including by casting, molding, machining or welding and may be assembled from a plurality of components or be integral.

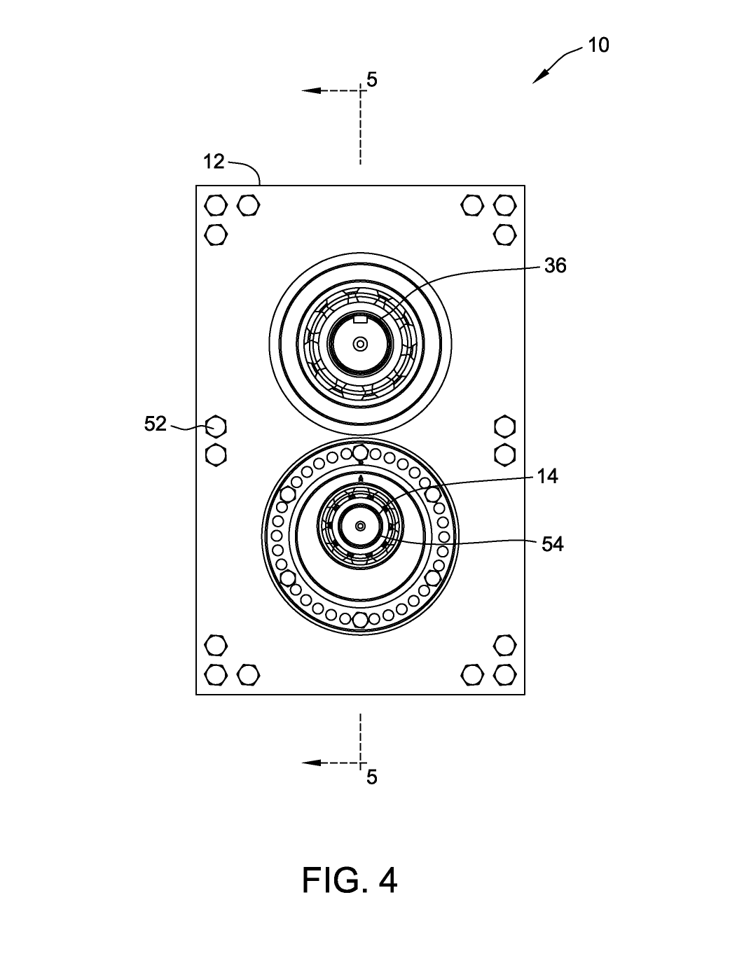

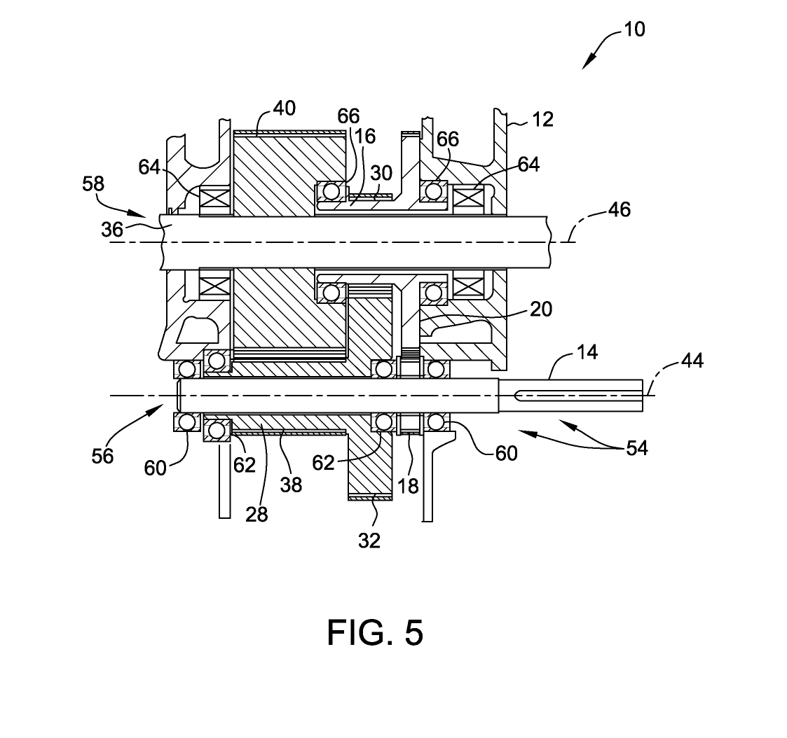

Referring now to FIGS. 4 and 5, the components within the housing 12 of the device 10 are shown in greater detail. As shown in FIG. 5, the shafts 14, 16, 28 and 36 are rotatably supported within the housing 12 by bearings 54. The bearings 54, as shown, are rolling element bearings, for example, ball or roller bearings. It should be appreciated that sleeve or journal bearings may alternatively be used. The bearings may be sealed, lubed for life, bearings that require no maintenance. As shown, each shaft has two or more spaced apart bearings, but it should be appreciated that a solitary bearing may be used to support a shaft. The bearings 54 may be mounted within a bore in the housing 12 or within a bore of a shaft or pulley. The shafts are also fitted to bores within the bearings.

As shown in FIG. 5, to minimize the size of the device 10, the first shaft 14 and the third shaft 28 rotate about first centerline 44 and the second shaft 16 and fourth shaft 36 rotate about second centerline 46. To provide for common rotation of the first shaft 14 and third shaft 28 about first centerline 44, the third shaft 28 defines a longitudinal central opening 56. The first shaft 14 rotates within the opening 56 of third shaft 28. The first shaft 14 is supported by first shaft bearings 60, which are mounted to housing 12 to provide rotation of first shaft 14. The third shaft 28 is supported by third shaft bearings 62. As shown, one of the third shaft bearings 62 is mounted to housing 12 and third shaft 28, while the other third shaft bearing 62 is mounted to first shaft 14 and to third shaft 28. As shown, the third shaft 28 is integral with the fourth pulley 32 and the fifth pulley 38, but alternate configurations, including the third shaft 28 being a separate component from the fourth pulley 32 and the fifth pulley 38 are anticipated.

Similarly, to provide for common rotation of the second shaft 16 and fourth shaft 36 about second centerline 46, the second shaft 16 defines a longitudinal central opening 58. The fourth shaft 36 rotates within the opening 58 of second shaft 16. The fourth shaft 36 is supported by fourth shaft bearings 64, which are mounted to housing 12 to provide rotation of fourth shaft 36. The second shaft 16 is supported by second shaft bearings 66. As shown, one of the second shaft bearings 66 is mounted to housing 12 and second shaft 16, while the other third shaft bearing 66 is mounted to second shaft 16 and to fourth shaft 36. As shown, the second shaft 16 is integral with the second pulley 20 and the third pulley 30, but alternate configurations, including the second shaft 16 being a separate component from the second pulley 20 and the third pulley 30 are anticipated.

The pulleys are fixed secured to the shafts or integral therewith to transmit torque through the shafts. As shown in FIG. 1, power from power source 24 is transmitted by input shaft 14 to first pulley 18 which is fixedly attached to input shaft 14. First belt 22 transmits torque from first pulley 18 to second pulley 20 which is fixedly secured to second shaft 16. Third pulley 30 is fixedly secured to second shaft 16 and transmits torque from second shaft 16 to third pulley 30. Second belt 34 transmits torque from third pulley 30 to fourth pulley 32 which is fixedly secured to third shaft 28. Fifth pulley 38 is fixedly secured to third shaft 28 and transmits torque from third shaft 28 to fifth pulley 38. Third belt 42 transmits torque from fifth pulley 38 to sixth pulley 40 which is fixedly secured to fourth shaft 36. Torque in sixth pulley 40 is transmitted to fourth shaft 36 and then to load 26.

The pulleys cooperate with the belts and, may for example be flat belts and pulleys, V-belts and pulleys or synchronous belts and pulleys having teeth. For example the belts may be Poly Chain GT® Carbon™ Belts available from Gates Corporation, Denver, Colo. and may be used with compatible pulleys also available from Gates Corporation

As shown in FIG. 1, the belts 22, 34 and 42 extend between common centerlines 44 and 46. As such, the lengths of the belts 22, 34 and 42 are dependent on each other and may, for simplicity, be of the same length.

Since the device 10 is a speed reduction device, the rotational speed of the input shaft 14 is much higher than the rotational speed of the output shaft 36. Conversely, the torque transmitted by the first belt 22 is much less than that transmitted by third belt 42, with the torque transmitted by the second belt 34 being of a value between those of the other two belts 22 and 42. As shown in FIG. 1 and to provide sufficient torque transmission strength, the second belt 34 is wider than the first belt 22 and the third belt 42 is wider than the second belt 34. By providing belts of the same length, same materials and the same cross-section (except for width) the belts will stretch the same and wear the same such that adjustment of the distance between centerlines 44 and 46 will provide adequate adjustment of all the belts.

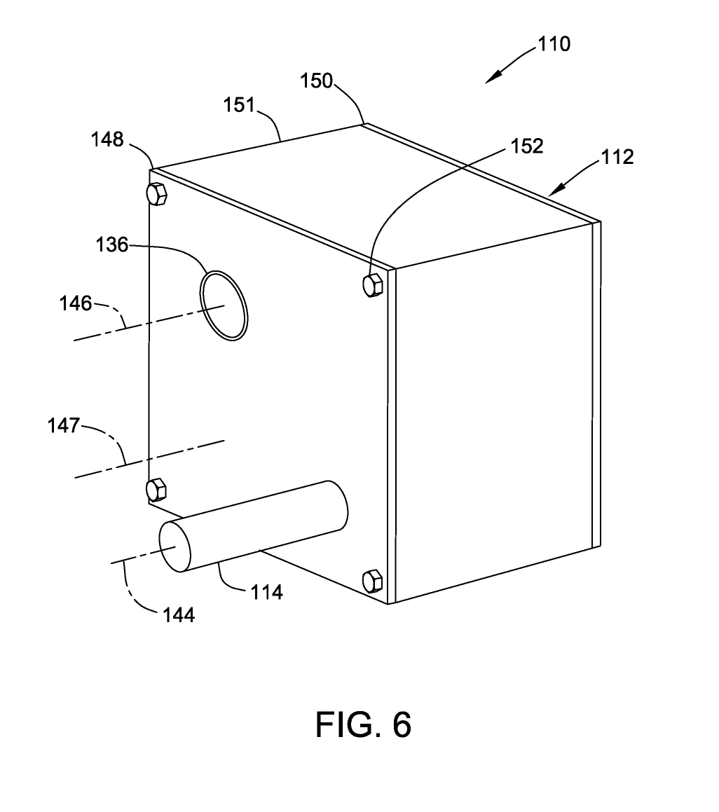

Referring now to FIGS. 6-8, another embodiment of the present invention is shown as speed reduction device 110. The device 110 of FIGS. 6-8 is similar to the device 10 of FIGS. 1-5, except the four shafts of device 110 are positioned along three different centerlines rather than the two different centerlines of the device 10.

Referring to FIG. 6, the housing 112 of device 110 is made from first and second steel plate end portions 148 and 150, respectively which are connected to steel central portion 151 and joined together by fasteners 152. The device includes a third rotational centerline 147 positioned intermediate to the first rotational centerline 144 and the second rotational centerline 146.

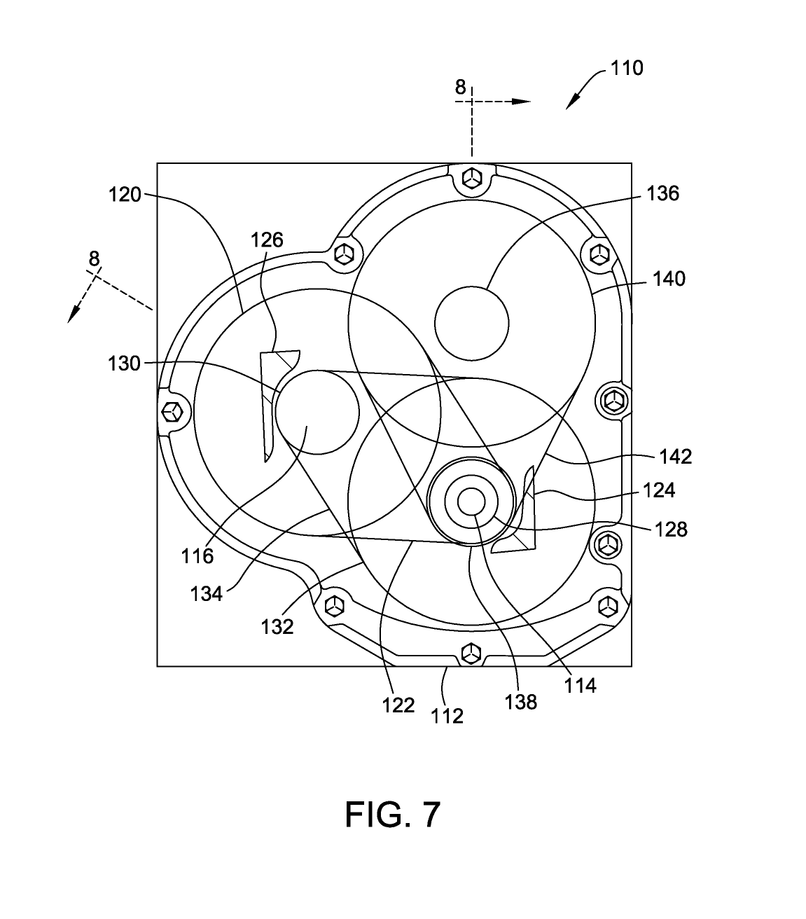

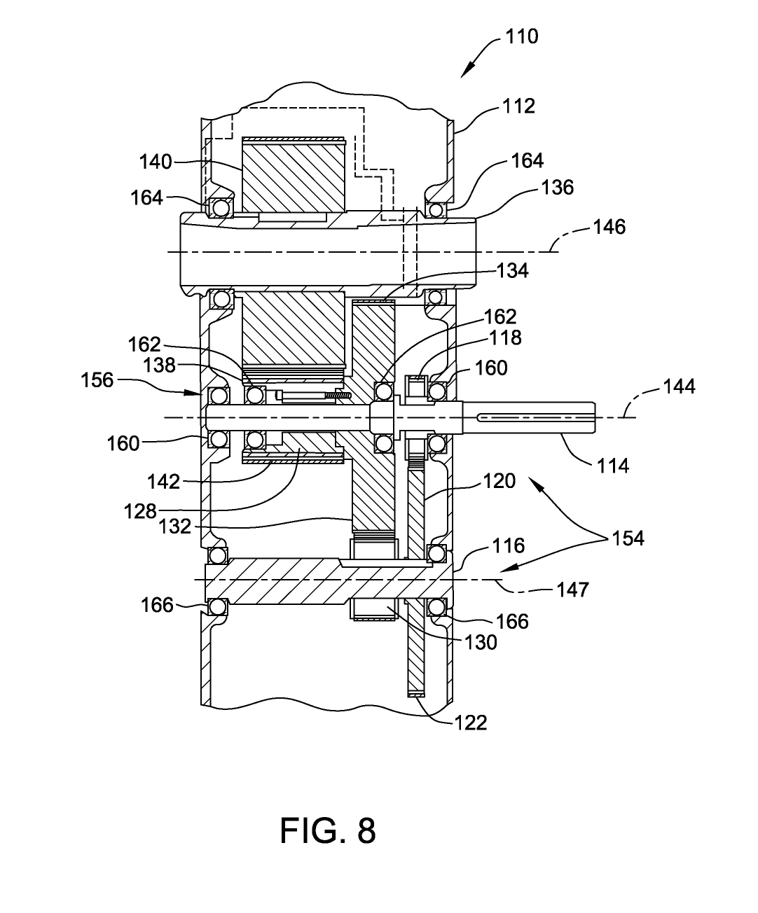

Referring now to FIGS. 7 and 8, the device 110 includes an input shaft 114 rotatably supported by housing 112 that receives power from power source 124. First pulley 118 is fixedly secured to input shaft 114. First belt 122 connects first pulley 118 to second pulley 120 that is fixedly secured to second shaft 116. Third pulley 130 is fixedly secured to second shaft 116. Second belt 134 connects third pulley 130 to fourth pulley 132 that is fixedly secured to third shaft 128. Fifth pulley 138 is fixedly secured to third shaft 128. Third belt 142 connects fifth pulley 138 to sixth pulley 140 that is fixedly secured to output shaft 136. The torque from output shaft 136 is transferred to load 126.

Referring to FIG. 8, the shafts are supported by bearings 154. The bearings 154 connect the shafts to the housing 112 and/or other shafts. The first shaft 114 is supported by first shaft bearings 160 rotatably supporting the input shaft 114 in housing 112. The second shaft 116 is supported by second shaft bearings 166 rotatably supporting the shaft in housing 112. Similarly, the fourth shaft 136 is supported by fourth shaft bearings 164 rotatably supporting the shaft in housing 112.

To reduce the size of the device 110, the input shaft 114 and the third shaft 128 rotate about first centerline 144. To provide for common rotation of the first shaft 114 and third shaft 128 about first centerline 144, the third shaft 128 defines a longitudinal central opening 156. The first shaft 114 rotates within the opening 156 of third shaft 128. The third shaft 128 is supported by third shaft bearings 162. As shown, one of the third shaft bearings 162 is mounted to housing 112 and third shaft 128, while the other third shaft bearing 162 is mounted to first shaft 114 and to third shaft 128. As shown, the third shaft 128 is integral with the fifth pulley 138, but alternate configurations, including the third shaft 128 being a separate component from the fifth pulley 138 are anticipated.

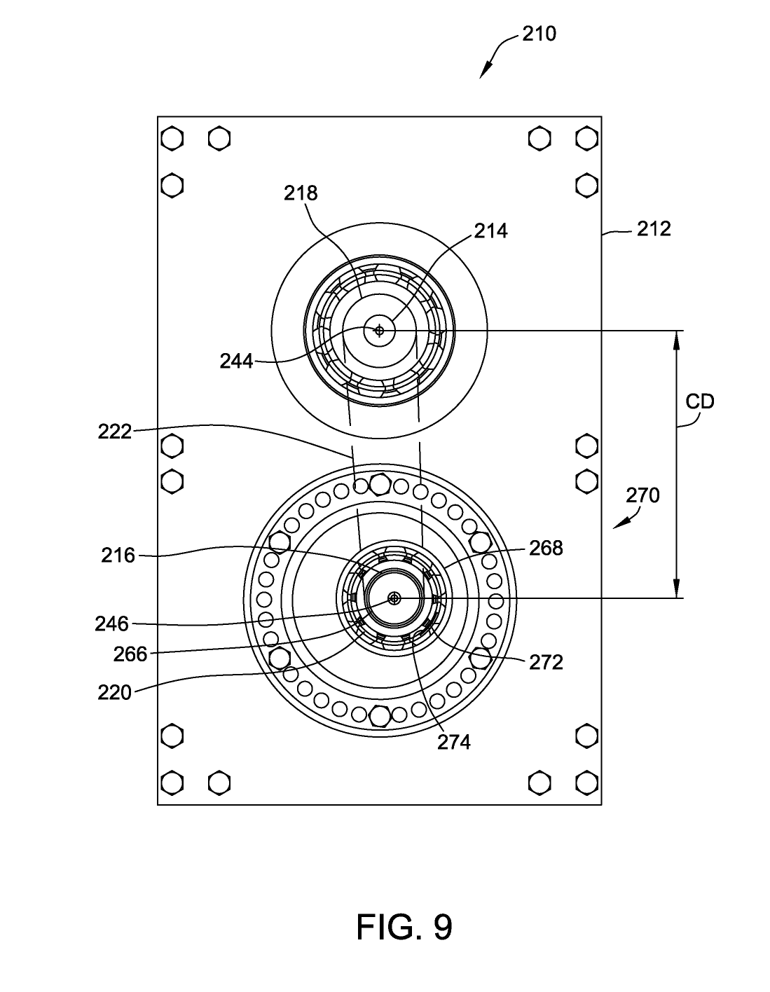

Referring now to FIG. 9, speed reduction device 210 is shown. The device 210 includes a tensioning device 270 to provide for belt replacement and to properly adjust the tension of the belts for a speed reduction device. The tensioning device 270 provides for the movement of the second axis of rotation 246 with respect to the first axis of rotation 244. The movement of the second axis of rotation 246 is typically accomplished by permitting movement of the second shaft bearings 266 supporting the second shaft 216 with respect to housing 212. Such movement can be accomplished by, for example, providing a bearing housing 268 for containing the bearings 266 and moving the bearing housing 268 with respect to the housing 212. The bearing housing 268 can for example, move discretely from one set of mounting holes (not shown) to another, slide along linear rails (not shown), pivot along arcuate rails. For simplicity and as shown in FIG. 9, the bearing housing 268 may be in the form of an adaptor ring 268 that includes a circular periphery 272 that mates with a circular opening 274 in housing 212. The bearings 266 are eccentrically positioned in adaptor ring 268 such that rotation of adaptor ring 268 in housing 212 adjusts center distance CD between the second axis of rotation 246 and the first axis of rotation 244. The adjusting of the center distance CD tightens and loosens belt 222 wrapped around first and second pulleys 218, 220, respectively.

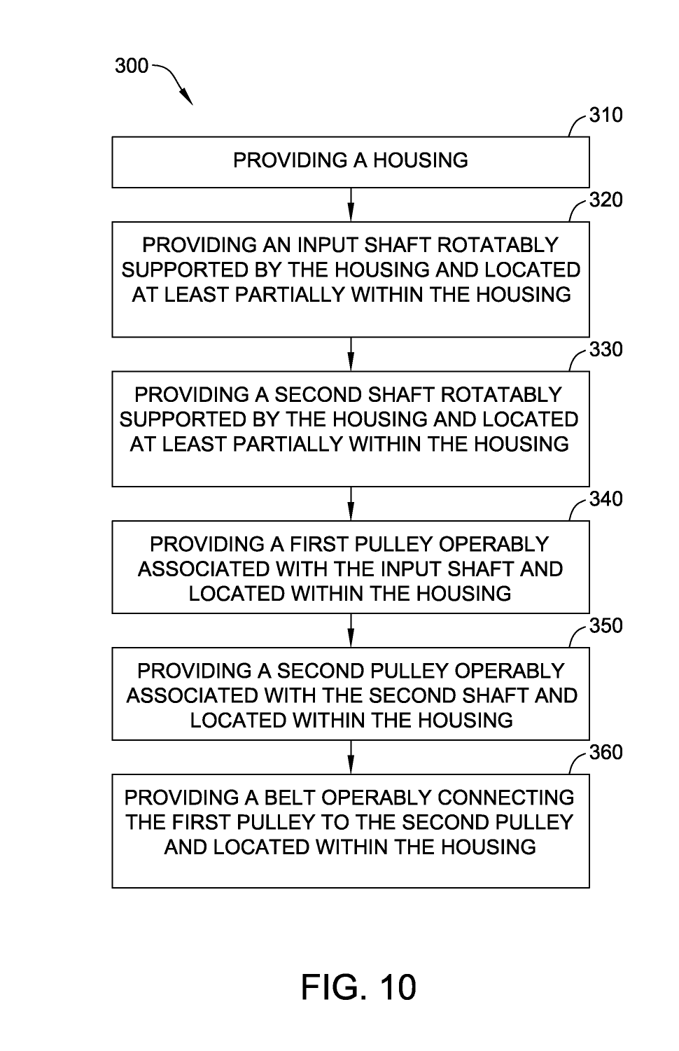

Referring now to FIG. 10, a flow chart of an exemplary method 300 for reducing speed of a power source for use to drive a load using a speed reduction device 10 (shown in FIG. 1) is shown. In the exemplary embodiment, method 300 includes the step 310 of providing a housing 12 (shown in FIG. 1), the step 320 of providing a input shaft 14 (shown in FIG. 1) rotatably supported by the housing and located at least partially within the housing, and the step 330 of providing a second shaft 16 (shown in FIG. 1) rotatably supported by the housing and located at least partially within the housing. The method 300 further includes the step 340 of providing a first pulley 18 (shown in FIG. 1) operably associated with the input shaft and located within the housing, the step 350 of providing a second pulley 20 (shown in FIG. 1) operably associated with the second shaft and located within the housing, and the step 360 of providing a belt 22 (shown in FIG. 1) operably connecting the first pulley to the second pulley and located within the housing.

The method 300 may be provided with the additional steps of providing an adjustment device 270 (shown in FIG. 9) to adjust the tension of the belt, rotating the adjustment device in a first direction to tighten the belt; and rotating the adjustment device in a second direction, opposed to the first direction, to tighten the belt.

The method 300 may be provided with the additional step of providing a third hollow shaft 28 (shown in FIG. 5) rotatably supported by the housing and the first shaft and located at least partially within the housing and the step of providing a third pulley 30 (shown in FIG. 5) operably associated with the second shaft and located within the housing. The method 300 may further include the step of providing a fourth pulley 32 (shown in FIG. 5) operably associated with the third shaft and located within the housing and the step of providing a second belt 34 (shown in FIG. 1) connecting the third pulley with the fourth pulley.

The methods, systems, and apparatus described herein facilitate efficient and economical speed reduction of a power source for adaptation to a load. Exemplary embodiments of methods, systems, and apparatus are described and/or illustrated herein in detail. The methods, systems, and apparatus are not limited to the specific embodiments described herein, but rather, components of each apparatus and system, as well as steps of each method, may be utilized independently and separately from other components and steps described herein. Each component, and each method step, can also be used in combination with other components and/or method steps.

When introducing elements/components/etc. of the methods and apparatus described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A speed reduction device for cooperation with a mechanical power source and with a mechanical power load, comprising:
a housing,
a input shaft rotatably supported by said housing and located at least partially within said housing;
a second shaft rotatably supported by said housing and located at least partially within said housing;
a first pulley operably associated with said input shaft and located within said housing;
a second pulley operably associated with said second shaft and located within said housing; and
a belt operably connecting said first pulley to said second pulley and located within said housing.

2. The speed reduction device in accordance with claim 1, further comprising:
a third shaft rotatably supported by at least one of said housing and said input shaft;
a third pulley operably associated with said second shaft and located within said housing;
a fourth pulley operably associated with said third shaft and located within said housing; and
a second belt operably connecting said third pulley to said fourth pulley and located within said housing.

3. The speed reduction device in accordance with claim 2:
wherein said input shaft defines an axis of rotation thereof; and
wherein said third shaft is configured for rotation about the axis of rotation of said input shaft;

4. The speed reduction device in accordance with claim 1, wherein said belt comprises teeth for cooperation with said first pulley and said second pulley.

5. The speed reduction device in accordance with claim 3, wherein said belt comprises teeth for cooperation with said first pulley and said second pulley.

6. The speed reduction device in accordance with claim 1, further comprising a mechanism for moving at least one of said first shaft and said second shaft with respect to the other of said first shaft and said second shaft to adjust tension to said belt.

7. The speed reduction device in accordance with claim 6, wherein said mechanism comprises an eccentric component.

8. The speed reduction device in accordance with claim 2, further comprising:
a fourth shaft rotatably supported by at least one of said housing and said second shaft;
a fifth pulley operably associated with said third shaft and located within said housing;
a sixth pulley operably associated with said fourth shaft and located within said housing; and
a third belt operably connecting said fifth pulley to said sixth pulley and located within said housing.

9. The speed reduction device in accordance with claim 8:
wherein said second shaft defines an axis of rotation thereof; and
wherein said fourth shaft is configured for rotation about the axis of rotation of said second shaft.

10. A speed reduction device for cooperation with a mechanical power source and with a mechanical power load, comprising:
a housing,
a input shaft rotatably supported by said housing and located at least partially within said housing;
a second shaft rotatably supported by said housing and located at least partially within said housing;
a first pulley operably associated with said input shaft and located within said housing;
a second pulley operably associated with said second shaft and located within said housing;
a first belt operably connecting said first pulley to said second pulley and located within said housing;
a third shaft rotatably supported by at least one of said housing and said input shaft;
a third pulley operably associated with said second shaft and located within said housing;
a fourth pulley operably associated with said third shaft and located within said housing; and
a second belt operably connecting said third pulley to said fourth pulley and located within said housing.

11. The speed reduction device in accordance with claim 10:
wherein said input shaft defines an axis of rotation thereof; and
wherein said third shaft is configured for rotation about the axis of rotation of said input shaft.

12. The speed reduction device in accordance with claim 10, wherein said first belt comprises teeth for cooperation with said first pulley and said second pulley.

13. The speed reduction device in accordance with claim 10, further comprising a mechanism for moving at least one of said first shaft and said second shaft with respect to the other of said first shaft and said second shaft to adjust tension and permit installation of said first belt.

14. The speed reduction device in accordance with claim 13, wherein said mechanism is configured for moving said third shaft with respect to at least one of said first shaft and said second shaft to adjust tension and permit installation said second belt.

15. The speed reduction device in accordance with claim 13, wherein said mechanism comprises an eccentric component.

16. The speed reduction device in accordance with claim 14, wherein said mechanism simultaneously moves at least one of said first shaft and said second shaft with respect to the other of said first shaft and said second shaft while said mechanism moves said third shaft with respect to at least one of said first shaft and said second shaft.

17. The speed reduction device in accordance with claim 10, said first belt and said second belt have substantially the same length

18. A speed reduction device for cooperation with a mechanical power source and with a mechanical power load, comprising:
a housing,
a input shaft rotatably supported by said housing and located at least partially within said housing;
a second shaft rotatably supported by said housing and located at least partially within said housing;
a first pulley operably associated with said input shaft and located within said housing;
a second pulley operably associated with said second shaft and located within said housing;
a first belt operably connecting said first pulley to said second pulley and located within said housing;
a third shaft rotatably supported by at least one of said housing and said input shaft;
a third pulley operably associated with said second shaft and located within said housing;
a fourth pulley operably associated with said third shaft and located within said housing;
a second belt operably connecting said third pulley to said fourth pulley and located within said housing;
a fourth shaft rotatably supported by at least one of said housing and said second shaft;
a fifth pulley operably associated with said third shaft and located within said housing;
a sixth pulley operably associated with said third shaft and located within said housing; and
a third belt operably connecting said fifth pulley to said sixth pulley and located within said housing.

19. The speed reduction device in accordance with claim 18:
wherein said input shaft defines an axis of rotation thereof; and
wherein said third shaft is configured for rotation about the axis of rotation of said input shaft;
wherein said second shaft defines an axis of rotation thereof; and
wherein said fourth shaft is configured for rotation about the axis of rotation of said second shaft.

20. The speed reduction device in accordance with claim 18, further comprising a mechanism for simultaneously adjusting the tension of said first belt, said second belt and said third belt.

21. The speed reduction device in accordance with claim 18, said first belt, said second belt and said third belt have substantially the same length.

22. A method reducing the speed of a drive, comprising:
providing a housing,
providing a input shaft rotatably supported by the housing and located at least partially within the housing;
providing a second shaft rotatably supported by the housing and located at least partially within the housing;
providing a first pulley operably associated with the input shaft and located within the housing;
providing a second pulley operably associated with the second shaft and located within the housing; and
providing a belt operably connecting the first pulley to the second pulley and located within the housing.

23. The speed reduction device in accordance with claim 22, further comprising;
providing an adjustment device to adjust the tension of the belt;
rotating the adjustment device in a first direction to tighten the belt; and
rotating the adjustment device in a second direction, opposed to the first direction, to tighten the belt.

24. The speed reduction device in accordance with claim 22, further comprising providing a third hollow shaft rotatably supported by said housing and said first shaft and located at least partially within said housing;
providing a third pulley operably associated with said second shaft and located within said housing;
providing a fourth pulley operably associated with said third shaft and located within said housing; and
providing a second belt operably connecting said third pulley to said fourth pulley and located within said housing.
